(19) United States
(12) Patent Application Publication
(10) Pub. No.: US 2008/0163208 A1
(43) Pub. Date: Jul. 3, 2008

(54) Virtual machine creation for removable storage devices

(76) Inventors: Jeremy Burr, Portland, OR (US); Brian Ostrovsky, Portland, OR (US)

Correspondence Address: BUCKLEY, MASCHOFF & TALWALKAR LLC, 50 LOCUST AVENUE, NEW CANAAN, CT, 06840, US

(21) Appl. No.: 11/647,721

(22) Filed: Dec. 29, 2006

(51) Int. Cl. G06F 9/455

(52) U.S. Cl. 718/1

(57) ABSTRACT

According to some embodiments, a removable storage device may be detected at a computer platform. The removable storage device may then be authenticated as a trusted device, and a secure virtual machine environment may be created within the computer platform in connection with the removable storage device.

### BACKGROUND

A computer platform, such as a Personal Computer (PC), may be able to exchange information with a removable mass storage device. For example, a PC may be able to load user files from a removable Universal Serial Bus (USB) Flash storage drive. In some cases, however, a user file or associated application may only be reliably accessed with a known system configuration (e.g., with a particular operating system and/or various device drivers). Moreover, a user might be concerned that unauthorized information may be copied from (or stored to) the removable storage device.

### BRIEF DESCRIPTION OF THE DRAWINGS

FIG. 1 is a block diagram of a system.

FIG. 2 is a block diagram of a system according to some embodiments.

FIG. 3 is a flow diagram illustrating a method according to some embodiments.

FIG. 4 is a flow diagram illustrating a method according to some embodiments.

FIG. 5 is a block diagram of a system according to some embodiments.

### DETAILED DESCRIPTION

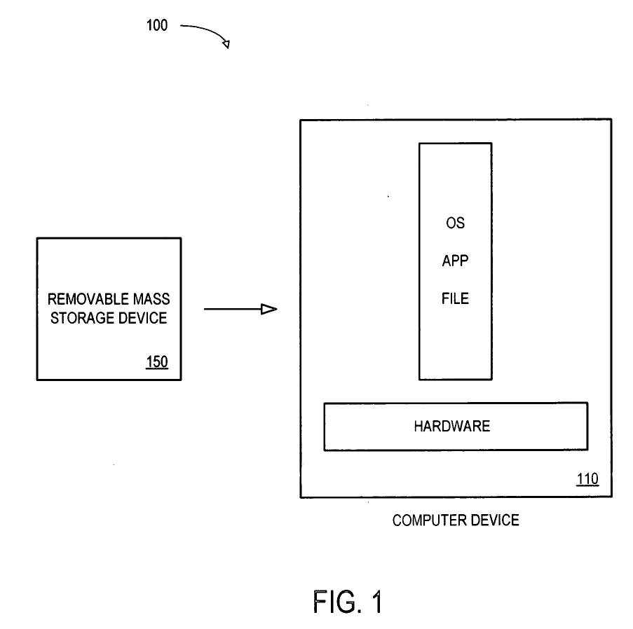

FIG. 1 illustrates a system 100 wherein a computer device 110 may exchange information with a removable mass storage device 150. The computer device 110 may be associated with, for example, a PC, a server, a mobile computer, a Personal Digital Assistant (PDA), a wireless telephone, and/or a media device (e.g., a set-top box). The computer device 110 may include applications, operating systems, and/or information files that are accessed via the hardware of the computer device 110.

The removable mass storage device 150 may be associated with, by way of examples only, a USB drive in accordance with the “Universal Serial Bus Revision 2.0 Specification” (2000), a flash memory or other non-volatile memory storage device, an Integrated Drive Electronics (IDE) device, an Advanced Technology Attachment (ATA) device, a micro hard drive, and/or a wireless Local Area Network (LAN) device in accordance with the Institute of Electrical and Electronics Engineers (IEEE) standard 802.11.

Although a single removable mass storage device 150 is illustrated in FIG. 1, note that any number of removable mass storage devices 150 may be provided in accordance with any of the embodiments described herein.

In some cases, a user file or associated application may only be reliably accessed with a known configuration of the system 100 (e.g., with a particular operating system, application, and/or various device drivers). Moreover, a user might be concerned that unauthorized information may be copied from (or stored to) the removable mass storage device 150.

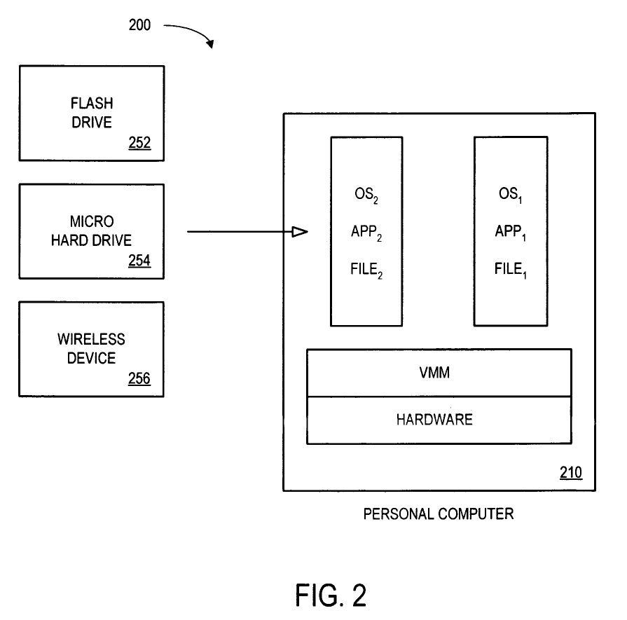

FIG. 2 is a block diagram of a system 200 according to some embodiments. As before, a PC 210 may exchange information with removable storage devices 252, 254, 256. In particular, the PC 210 may exchange information with a flash drive 252, a micro hard drive 254, and/or a wireless device 256. Moreover, the PC 210 includes a Virtual Machine Monitor (VMM) that may let different sets of operating systems, applications, and/or files be accessed with the hardware of the PC 210. As used herein, a VMM may, for example, virtualize a computer system physical resources to achieve improved sharing an utilization of processors, memory, and/or IO devices. The VMM may, for example, arbitrate access to underlying physical host platform resources in a secure manner. For example, a first set (OS₁, APP₁, FILE₁) may be isolated from a set (OS₂, APP₂, FILE₂).

According to some embodiments, the PC 210 may detect the presence of one or more of the removable storage devices 252, 254, 256. In response to the detection, the PC 210 may authenticate the removable storage device as a trusted device. Moreover, in response to the detection and/or authentication, the PC 210 may create a secure virtual machine environment within the computer platform in connection with the removable storage device. For example, the PC 210 may load an operating system into the secure virtual machine environment and launch, via the operating system, a user application within the secure virtual machine environment.

According to some embodiments, the system 200 may launch, via a Basic Input/Output System (BIOS) associated with the computer platform, a user application within the secure virtual machine environment and/or access a user file from the secure virtual machine environment. In some cases, the creation of the secure virtual machine environment for the removable storage device may need to be authorized. For example, when a removable storage device is detected via a network the PC 210 may use passwords, user identifier, encryption and/or other authentication techniques to authorize the creation of the secure virtual machine.

Note that the PC 210 may include a processor adapted to support a plurality of secure virtual machine environments, a detection unit to detect the removable storage devices 252, 254, 256, and/or an authentication unit to authenticate one or more of the removable storage devices 252, 254, 256 as a trusted device. Moreover, a secure virtual machine environment is created, in response to said detection and authentication, in connection with the removable storage device 252, 254, 256. According to some embodiments, at least one of the following is to be retrieved from the removable storage device: an operating system, a user application, or a user file. Moreover, the PC 210 may include a virtual machine monitor that instantiates the secure virtual machine environment for the removable storage device 252, 254, 256.

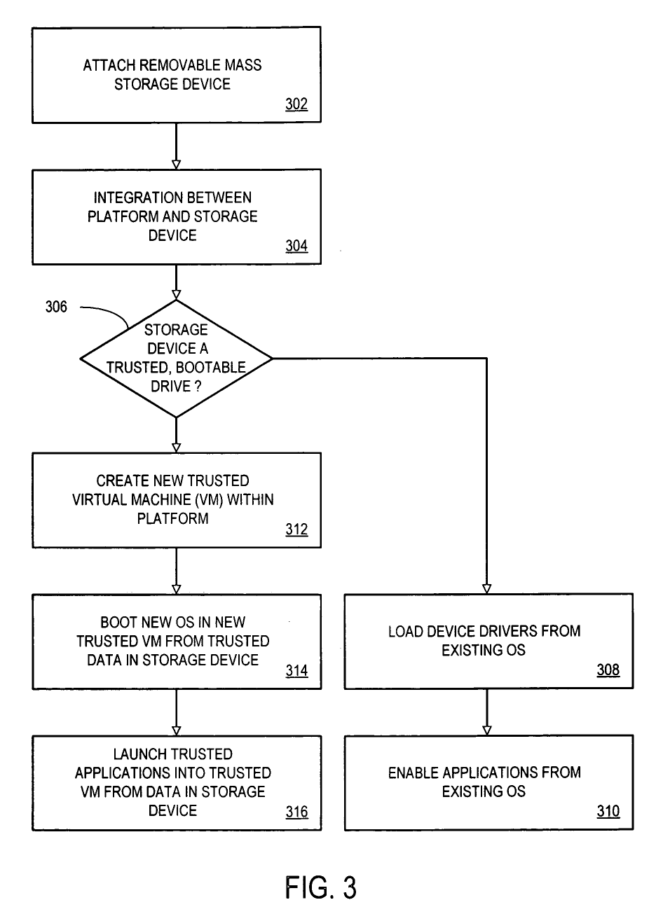

FIG. 3 is a flow diagram illustrating a method according to some embodiments. The method may be performed, for example, using the system 200 of FIG. 2. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 302, a removable storage device is attached to a computer platform. At 304, integration between the platform and the storage device is performed (e.g., in accordance with plug and play protocols). For example, the computer platform may determine whether or not an inserted USB drive is a trusted, bootable device. Consider a boot-up process for a typical computer platform that begins with the first calls being made to the BIOS Read Only Memory (ROM). These instructions may set up the underlying system upon which later software structures, such as the operating system, can be built. In some cases, these and subsequent instructions are performed in a secure manner, to create a trusted environment within which (i) peripherals can be attached and their drivers loaded, and (ii) applications can be launched which are guaranteed not to interact with one another. Similarly, operating systems can subsequently be launched into this trusted environment.

In some cases, a system may scan the various drives in a set order, looking for suitable operating systems to load, and subsequently scan pre-assigned directory locations to load additional peripherals and launch additional applications. Such operating system may define the entire environment within which applications can be launched. Also note that some technologies developed for trusted platforms allow secure virtual machines run independently on silicon. That is, they allow the ability to load an operating system in such a secure virtual machine, and, in consequence, have multiple different operating systems loaded simultaneously within independent secure virtual machines.

The mass storage devices for PC platforms are often maintained within the chassis itself, attaching to the serial ATA ports. According to some embodiments described herein, such fixed mass storage devices may become optional because all mass storage could be maintained within the removable storage devices. Note that data transfer rates and storage capacities are becoming comparable between fixed internal hard drives and removable drives.

According to some embodiments, during the interrogation and/or authentication process of 304 and 306, the removable mass storage device may identify itself as a secure and/or trusted device which contains an operating system and user environment (e.g., applications and user data) that may require a secure virtual machine environment.

If the storage device is not a trusted, bootable drive at 306, then device drives might be loaded from an existing operating system at 308. One or more applications may then be enabled from the existing operating system at 310.

If, however the storage device was not a trusted, bootable drive at 306, then a new virtual machine may be created within the computer platform at 312. Moreover, a new operating system may be booted within the new trusted virtual machine from data stored on the storage device at 314. One or more applications may then be enabled and launched into the virtual machine from data stored on the storage device at 316.

The introduction of virtualization into silicon may mean that significantly more complex programs can be manipulated using removable storage. For example, a company might have a business application that only reliably runs in a known system configuration. The company's sales force can now be provided with the known-reliable operating system configuration and the company's complete business application and database, all within a removable device that can be installed at a customer's worksite. Note that the configuration might be provided without concern for the other operating systems or applications running on the customer's computer, because the company's proprietary system may initiate a new protected virtual machine within the customer's platform within which the software can run. After the customer interaction is concluded, the virtual machine may be terminated and consequently all proprietary data can be removed from the volatile memory within the customer's platform. The visiting sales person would then have physical ownership of all the company's proprietary information during the customer interaction.

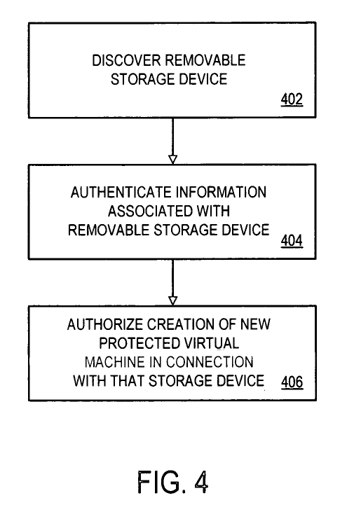

FIG. 4 is a flow diagram illustrating a method according to some embodiments. At 402, a removable storage device is discovered. The storage device may be discovered, for example, via a wired or wireless attachment. Information associated with the removable storage device may then be authenticated at 404, and creation of a new protected virtual machine, in connection with that storage device, may be authorized at 406. Thus, the process may help ensure that a fully bootable operating system and user environment contained within the removable storage device will integrate cleanly and securely into the real-time, distributed, trusted environment.

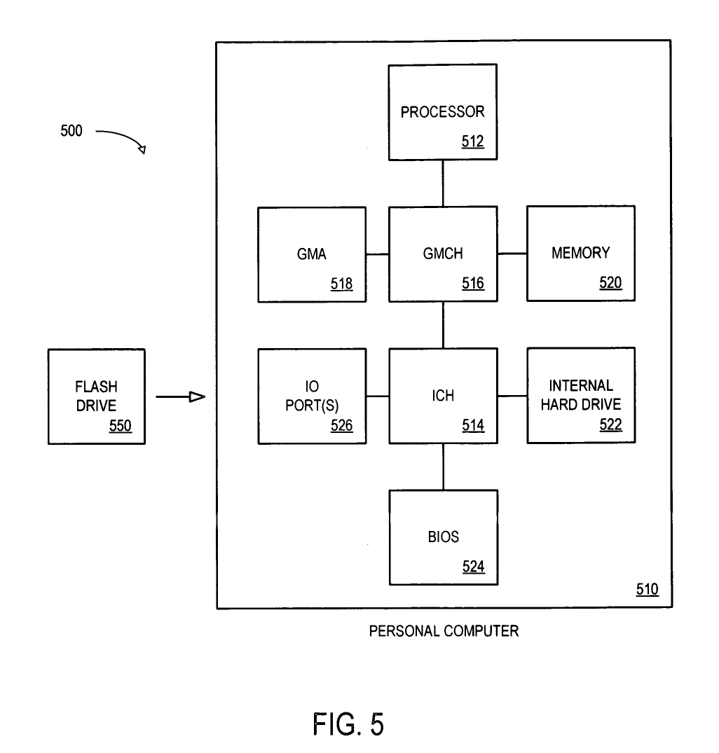

FIG. 5 is a block diagram of a system 500 according to some embodiments. The system 500 includes a PC 510 that may include, for example, a processor 512 couple to a memory 520, a Graphics Media Accelerator (GMA) 818, and an IO Controller Hub (ICH) 514 through a Graphics Memory Controller Hub 516. The ICH 514 may provide access to, for example, IO ports 526, an internal hard drive 522, and/or the BIOS 524.

As before, the PC 510 that may exchange information with a flash drive 550. Note that any type of removable storage device might be associated with embodiments described herein, including: a micro hard-disk drive, a serial port device, a parallel port device, a memory card, an optical disk drive, a solid state storage device, a molecular based memory device, a network device, or a wireless device.

Although some embodiments described herein are associated with a boot-up process for an operating system within a newly created virtual machine, embodiments may be applicable to any software that is launched within the virtual machine when the virtual machine is created due to the discovery, authentication, and/or authorization protocol that identifies that a specific removable mass storage device requires the creation of a new protected virtual machine within a computing platform. For example, a specific application program may require a protected virtual machine environment within a PC, but not require the launching of an underlying operating system prior to the application being launched (it might be able to run directly on top of the newly instantiated BIOS layer within a newly created virtual machine).

Thus, embodiments may allow the removable media to create their own protected environments and load their preferred operating systems, before launching their desired applications. This may provide a much more secure environment in which the applications can run, and let a user maintain physical ownership of the operating system and application programs (because they might not be loaded into the non-volatile sections of the PC). Moreover, embodiments described herein may extend concepts of virtualization and trusted platforms to removable storage media.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to a physical, electrical connection between the removable storage device and a PC platform, embodiments may be associated to other networked storage devices that can initiate discovery, authentication, and/or authorization over a network, including: wire-line storage devices (where the physical connection of the Ethernet cable initiates plug & play activity); wireless storage devices (where the over-the-air discovery of a new device/access point in proximity initiates plug & play activity); wire-line or wireless storage devices with distributed resources (where the physical cable connection or air interface discovery initiates plug & play activity, but the required resources are situated remotely from the initial device/PC platform).

By way of example, consider a PC platform with no hard drive that is subsequently connected to a wired network via an Ethernet TCP/IP connection. In this case, the PC platform may now provide remote Central Processing Unit (CPU) processing cycles to the network, and external processes with their own local storage may choose to initiate trusted authentication onto the platform, create new virtual machines, perform their tasks and then terminate the virtual machines at the end of the desired tasks.

As another example, consider a PC platform with 802.11 access point capability. In this case, a user may walk up to a platform holding a Personal Digital Assistant (PDA) that has 802.11 wireless capability. Instead of physically connecting a USB-based Flash device to the PC, the user activates the PDA as the Flash storage device. The 802.11 interrogation with the PDA may start the trusted virtual machine within the PC, boot up the user's preferred OS, launch the user's desired applications within this OS, and thus access substantially greater computing power than previously available within the PDA.

Note that the PDA in this example provides may IO functionality such as display/keypad/buttons, which are not utilized within the interaction given above. To reduce the cost of the system, these features could be omitted, with all the IO functions being provided by the host PC platform. In this way, multiple people might have simultaneous access to the environment's computing resources (e.g., they all might be provided with shared but independent and protected access to the PC's computing power and I/O resources).

As still another example, consider devices with distributed resources. For example, a user with a cell phone may walk up to a PC platform, and the phone may initiate a trusted virtual machine for the user. The cell phone may securely tunnel through and download over the cell phone's network the user's desired operating system, applications, and data. In this case, the user may now have access to the platform's computing resources and IO abilities. In some cases, the cell phone might authorize the download and then securely tunnel through and perform this download over the PC platform's Ethernet TCP/IP connection and then boot up the user's desired operating system, applications, and data.

As yet another example, a user may approach a PC computing platform with a USB Flash storage device or 802.11-enabled Flash storage device and initiate a secure link to a proximate PC platform. The device then requests access to the necessary computing power (perhaps this particular PC is under-featured), and the proximate PC transparently determines the best path (e.g., using least cost routing) or best processing choice on a remote PC platform to meet the user's requirements. The interrogation may then tunnel into that remote PC platform, authenticate and authorize a trusted virtual machine on the remote platform. The device can boot up the desired operating system on that platform, launch the desired applications, and perform the desired tasks.

The several embodiments described herein are solely for the purpose of illustration. Persons skilled in the art will recognize from this description other embodiments may be practiced with modifications and alterations limited only by the claims.

What is claimed is:

1. A method, comprising:
detecting a removable storage device at a computer platform;
authenticating the removable storage device as a trusted device; and
creating, in response to said detection and authentication, a secure virtual machine environment within the computer platform in connection with the removable storage device.

2. The method of claim 1, further comprising:
loading an operating system into the secure virtual machine environment.

3. The method of claim 2, further comprising:
launching, via the operating system, a user application within the secure virtual machine environment.

4. The method of claim 1, further comprising:
launching, via a basic input/output system associated with the computer platform, a user application within the secure virtual machine environment.

5. The method of claim 1, further comprising:
accessing a user file from the secure virtual machine environment.

6. The method of claim 1, further comprising:
authorizing creation of the secure virtual machine environment for the removable storage device.

7. The method of claim 1, wherein the removable storage device is associated with at least one of: (i) a flash drive, (ii) a micro hard-disk drive, (iii) a serial port device, (iv) a parallel port device, (v) a memory card, (vi) an optical disk drive, (vii) a solid state storage device, (viii) a molecular based memory device, (ix) a network device, or (x) a wireless device.

8. The method of claim 1, wherein the removable storage device is detected via a network.

9. An apparatus comprising:
a processor adapted to support a plurality of secure virtual machine environments;
a detection unit to detect a removable storage device; and
an authentication unit to authenticate the removable storage device as a trusted device, wherein a secure virtual machine environment is created, in response to said detection and authentication, in connection with the removable storage device.

10. The apparatus of claim 9, wherein at least one of the following is to be retrieved from the removable storage device: (i) an operating system, (ii) a user application, or (iii) a user file.

11. The apparatus of claim 9, further comprising:
a virtual machine monitor to instantiate the secure virtual machine environment for the removable storage device.

12. The apparatus of claim 9, wherein the removable storage device is associated with at least one of: (i) a flash drive, (ii) a micro hard-disk drive, (iii) a serial port device, (iv) a parallel port device, (v) a memory card, (vi) an optical disk drive, (vii) a solid state storage device, (viii) a molecular based memory device, (ix) a network device, or (x) a wireless device.

13. A computer-readable storage medium having stored thereon instructions that when executed by a machine result in the following: detection of a removable storage device at a computer platform,
authentication of the removable storage device as a trusted device, and
creation, in response to said detection and authentication, of a secure virtual machine environment within the computer platform in connection with the removable storage device.

14. The medium of claim 13, wherein execution of the instructions further results in:
loading of an operating system into the secure virtual machine environment.

15. The medium of claim 14, wherein execution of the instructions further results in:
launching, via the operating system, of a user application within the secure virtual machine environment.

16. The medium of claim 13, wherein execution of the instructions further results in:
launching, via a basic input/output system associated with the computer platform, a user application within the secure virtual machine environment.

17. The medium of claim 13, wherein execution of the instructions further results in:
accessing a user file from the secure virtual machine environment.

18. The medium of claim 13, wherein the removable storage device is associated with at least one of: (i) a flash drive, (ii) a micro hard-disk drive, (iii) a serial port device, (iv) a parallel port device, (v) a memory card, (vi) an optical disk drive, (vii) a solid state storage device, (viii) a molecular based memory device, (ix) a network device, or (x) a wireless device.

19. A system, comprising:
a processor adapted to support a plurality of secure virtual machine environments;
an internal storage device to be associated with a first secure virtual machine environment;
a detection unit to detect a removable storage device; and
an authentication unit to authenticate the removable storage device as a trusted device, wherein a second secure virtual machine environment is created, in response to said detection and authentication, in connection with the removable storage device.

20. The system of claim 19, wherein the removable storage device is associated with at least one of: (i) a flash drive, (ii) a micro hard-disk drive, (iii) a serial port device, (iv) a parallel port device, (v) a memory card, (vi) an optical disk drive, (vii) a solid state storage device, (viii) a molecular based memory device, (ix) a network device, or (x) a wireless device.

21. A method, comprising:
coupling a removable storage device with a computer platform;
authenticating the removable storage device as a trusted device; and
accessing the computer platform via a secure virtual machine environment created in response to said authentication.

22. The method of claim 21, wherein the removable storage device is associated with at least one of: (i) a flash drive, (ii) a micro hard-disk drive, (iii) a serial port device, (iv) a parallel port device, (v) a memory card, (vi) an optical disk drive, (vii) a solid state storage device, (viii) a molecular based memory device, (ix) a network device, or (x) a wireless device.
